(19) United States
(12) Patent Application Publication
(10) Pub. No.: US 2022/0084327 A1
(43) Pub. Date: Mar. 17, 2022

(54) AUTOMOBILE DIAGNOSIS METHOD, APPARATUS AND SYSTEM

(71) Applicant: Autel Intelligent Technology Corp., Ltd., Shenzhen (CN)

(72) Inventor: Minghua ZHAO, Shenzhen (CN)

(73) Assignee: Autel Intelligent Technology Corp., Ltd., Shenzhen (CN)

(21) Appl. No.: 17/534,480

(22) Filed: Nov. 24, 2021

Related U.S. Application Data
(63) Continuation of application No. PCT/CN2020/096812, filed on Jun. 18, 2020.

(30) Foreign Application Priority Data
Jun. 19, 2019 (CN) 201910530873.6

(51) Int. Cl. G07C 5/00; G06F 9/455; G05B 23/02; G07C 5/08

(52) U.S. Cl. CPC G07C 5/008; G07C 5/0816; G05B 23/0262; G06F 9/45533

(57) ABSTRACT

The disclosure provides an automobile diagnosis method, apparatus and system. The method is applicable to a terminal device. The terminal device is communicatively connected to an automobile and includes virtual machine software and pieces of original instrument software. The virtual machine software runs virtual machines. The method includes: determining a piece of original instrument software for automobile diagnosis from the pieces of original instrument software; determining a virtual machine for running the piece of original instrument software from the virtual machines; acquiring fault data of the automobile; and controlling the virtual machine to run the piece of original instrument software, so that the piece of original instrument software analyzes the fault data to perform diagnosis for the automobile. The implementation is applicable to diagnosis of automobiles of many types, has an enhanced universality and improves stability of automobile diagnosis.

### CROSS-REFERENCE OF RELATED APPLICATIONS

This application is a continuation application of International Application No. PCT/CN2020/096812, filed on Jun. 18, 2020, which claims priority of Chinese Patent Application No. 201910530873.6, filed on Jun. 19, 2019, which is incorporated herein by reference in its entirety.

### TECHNICAL FILED

The present application relates to the technical field of automobile diagnosis, and in particular, to an automobile diagnosis method, apparatus and system.

### DESCRIPTION OF RELATED ART

Automobiles are the most familiar and common transportation means for people, and play a very important role in people's life. As owned automobiles increase, automobile function diagnosis is particularly important.

At present, automobile diagnosis is mainly performed in two manners. In a first manner, an original diagnosis instrument is used for automobile diagnosis. The original diagnosis instrument is software running on a computer side. Generally, one type of original diagnosis instrument is adapted to automobiles of a specific brand. In a second manner, a third-party diagnosis instrument is used for automobile diagnosis and diagnosis information read by the third-party diagnosis instrument is remotely transmitted to a remote server. The third-party diagnosis instrument has a remote diagnosis function and is adapted to automobiles of many brands.

In the related art, the original diagnosis instrument does not cover all vehicles types and is therefore not versatile, and the third-party diagnosis instrument lacks stability although it is versatile.

### SUMMARY

A technical problem to be resolved in the disclosure is to provide an automobile diagnosis method, apparatus and system. The automobile diagnosis method, apparatus and system resolve technical problems such as coverage of only a limited range of vehicle types and poor stability of diagnosis software during automobile diagnosis in the related art.

An aspect of embodiments of the disclosure provides an automobile diagnosis method, applicable to a terminal device. The terminal device is communicatively connected to an automobile. The terminal device includes virtual machine software and a plurality of pieces of original instrument software. The virtual machine software runs a plurality of virtual machines. The method includes:

determining a piece of original instrument software for automobile diagnosis from the plurality of pieces of original instrument software;

determining a virtual machine for running the piece of original instrument software from the plurality of virtual machines;

acquiring fault data of the automobile; and

controlling the virtual machine to run the piece of original instrument software, so that the piece of original instrument software analyzes the fault data to perform diagnosis for the automobile.

Optionally, determining a piece of original instrument software for automobile diagnosis from the plurality of pieces of original instrument software includes:

acquiring original software information of the automobile; and

determining the piece of original instrument software for the automobile diagnosis from the plurality of pieces of original instrument software according to the original software information.

Optionally, acquiring original software information of the automobile includes:

acquiring a vehicle identification number (VIN) of the automobile and acquiring the original software information of the automobile according to the VIN; or

acquiring the original software information of the automobile from a remote server.

Optionally, the controlling the virtual machine to run the piece of original instrument software includes:

receiving an input command from a user, the input command being a command transmitted by the user to the terminal device by using a cloud server; and

controlling, according to the input command from the user, the virtual machine to run the piece of original instrument software.

Optionally, the method further includes:

transmitting a diagnosis result of the automobile to the user.

An aspect of embodiments of the disclosure provides an automobile diagnosis apparatus, applicable to a terminal device. The terminal device is communicatively connected to an automobile. The terminal device includes virtual machine software and a plurality of pieces of original instrument software. The virtual machine software runs a plurality of virtual machines. The apparatus includes:

an original instrument determination module, configured to determine a piece of original instrument software for automobile diagnosis from the plurality of pieces of original instrument software;

a virtual machine determination module, configured to determine a virtual machine for running the piece of original instrument software from the plurality of virtual machines;

a data acquisition module, configured to acquire fault data of the automobile; and

a diagnosis module, configured to control the virtual machine to run the piece of original instrument software, so that the piece of original instrument software analyzes the fault data to perform diagnosis for the automobile.

Optionally, the original instrument determination module includes:

an information acquisition unit, configured to acquire original software information of the automobile; and

an original instrument determination unit, configured to determine the piece of original instrument software for the automobile diagnosis from the plurality of pieces of original instrument software according to the original software information.

Optionally, the information acquisition unit is specifically configured to:

acquire a VIN of the automobile and acquire the original software information of the automobile according to the VIN; or

acquire the original software information of the automobile from a remote server.

Optionally, the diagnosis module is specifically configured to:

receive an input command from a user, the input command being a command transmitted by the user to the terminal device by using a cloud server; and

control, according to the input command from the user, the virtual machine to run the piece of original instrument software, so that the piece of original instrument software analyzes the fault data to perform diagnosis for the automobile.

Optionally, the apparatus further includes:

an information transmission module, configured to transmit a diagnosis result of the automobile to the user.

Still another aspect of the embodiments of the disclosure provides an automobile diagnosis system. The system includes a terminal device and an interface.

The terminal device includes at least one processor and a memory communicatively connected to the at least one processor. The memory stores instructions which are executable by the at least one processor to perform the foregoing method.

The interface is configured to connect the terminal device to an automobile.

Optionally, the system further includes:

a cloud server communicatively connected to the terminal device and configured to remotely control the terminal device to perform diagnosis for the automobile.

Optionally, the interface is a vehicle diagnosis adapter adapted to original instrument software of a preset type.

In the embodiments of the disclosure, the virtual machine software and the plurality of pieces of original instrument software are installed in the terminal device and the plurality of virtual machines are configured in the virtual machine software. During the automobile diagnosis, the piece of original instrument software for the current automobile diagnosis is determined from the plurality of pieces of original instrument software, the virtual machine for running the piece of original instrument software is selected from the plurality of virtual machines, and then the fault data of the automobile is acquired, and finally the piece of original instrument software is run by using the virtual machine. During the running, the piece of original instrument software analyzes the fault data to complete the diagnosis of the automobile. In this implementation, the terminal device for automobile diagnosis includes the plurality of pieces of original instrument software installed locally in the terminal device. Therefore, the implementation is applicable to diagnosis of automobiles of many types, has an enhanced universality, and improves stability of automobile diagnosis.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a structural block diagram of an automobile diagnosis system according to an embodiment of the disclosure.

FIG. 2 is a flowchart of an automobile diagnosis method according to an embodiment of the disclosure.

FIG. 3 is a schematic structural diagram of an automobile diagnosis apparatus according to an embodiment of the disclosure.

### DETAILED DESCRIPTION

To make the objectives, technical solutions and advantages of the disclosure clearer and more comprehensible, the following further describes the disclosure in detail with reference to the accompanying drawings and embodiments. It should be understood that the embodiments herein are provided for describing the disclosure and not intended to limit the disclosure.

It should be noted that, if no conflict occurs, features in the embodiments of the disclosure may be combined with each other and fall within the protection scope of the disclosure. In addition, although functional module division is performed in the schematic diagram of the apparatus, and a logical sequence is shown in the flowchart, in some cases, the shown or described steps may be performed by using module division different from the module division in the schematic diagram of the apparatus, or in a sequence different from the sequence in the flowchart.

The embodiments of the disclosure include an automobile diagnosis system, an automobile diagnosis method and an automobile diagnosis apparatus. The automobile diagnosis method is applicable to a terminal device. The terminal device is communicatively connected to a to-be-diagnosed automobile and includes virtual machine software and a plurality of pieces of original instrument software. A plurality of virtual machines are run in the virtual machine software. When a plurality of automobiles need to be diagnosed, a piece of original instrument software adapted to a current automobile is selected from the plurality of pieces of original instrument software and a virtual machine for running the piece of original instrument software is selected from the plurality of virtual machines. In addition, the terminal device acquires fault data of the to-be-diagnosed automobile, then runs the piece of original instrument software by using the determined virtual machine, and analyzes the fault data by using the piece of original instrument software, to obtain a diagnosis result of the automobile. During running of the piece of original instrument software by using the virtual machine, the piece of original instrument software may be operated locally or remotely.

The automobile diagnosis system, the automobile diagnosis method and the automobile diagnosis apparatus provided in the embodiments of the disclosure can achieve various beneficial effects. For example, diagnosis of automobiles of various types can be performed. For another example, a local original instrument may be used for automobile diagnosis. In this way, stability of the automobile diagnosis is maintained.

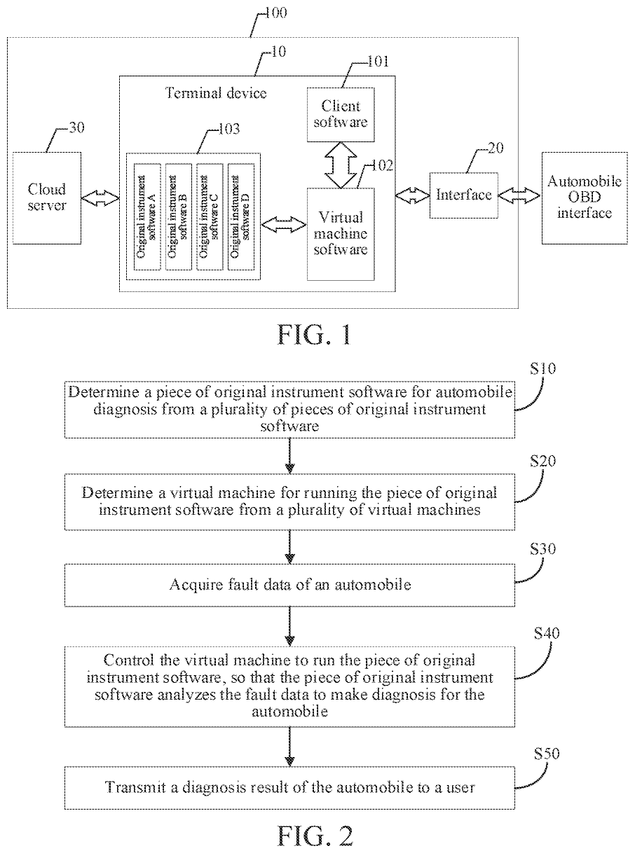

FIG. 1 is a structural block diagram of an automobile diagnosis system according to an embodiment of the disclosure. As shown in FIG. 1, an automobile diagnosis system 100 includes a terminal device 10 and an interface 20. The terminal device 10 is communicatively connected to a to-be-diagnosed automobile by using the interface 20.

The terminal device 10 may be a computer, such as a desktop computer, a notebook computer or the like. A system of the computer may be a Linux operating system, a Windows operating system, or a macOS operating system. The terminal device 10 includes one or more processors and a memory, which may be connected by using a bus or in other manners. The processors may be one or more microprocessors or control circuits of another type, such as one or more application specific integrated circuits. As a non-volatile computer-readable storage medium, the memory may be configured to store non-volatile software programs, non-volatile computer-executable programs and modules. For example, the memory stores a plurality of pieces of original instrument software and virtual machine software.

In this embodiment, as shown in FIG. 1, the terminal device 10 includes client software 101, virtual machine software 102 and a plurality of pieces of original instrument software 103. The client software and the virtual machine software may be loaded in the memory of the terminal device 10. The plurality of pieces of original instrument software may be stored in a local hard disk of the terminal device 10. For example, image files of a plurality of pieces of original instrument software of different types are stored in the local hard disk.

The client software 101 is run in the terminal device 10 and provides an access for a user to access the piece of original instrument software, which may be specifically a website or specific software. A registration function may be added for a user who is to access the client software 101. The client software 101 can be used only after the user registers an account and logs into the client software. The client software 101 is run in the memory of the terminal device 10.

The virtual machine software 102 is software configured to run a virtual system. The software may specifically be VMware or the like. A plurality of virtual machines may be built in the virtual machine software 102. The virtual machines are configured to run the piece of original instrument software 103. The plurality of virtual machines may correspond to the plurality of pieces of original instrument software 103 in a one-to-one manner. The virtual machines are virtual system environments exclusive to the piece of original instrument software 103. The virtual machine software 102 is run in the memory of the terminal device 10 after being enabled.

The piece of original instrument software 103 is software run in the terminal device 10, which is used for fault diagnosis of the automobile. Automobiles of different brands correspond to corresponding original instrument software. The plurality of pieces of original instrument software are the original instrument software corresponding to the automobiles of the plurality of brands. A quantity and a type of original instrument software may be preset according to factors such as a market demand, user preferences and the like. The piece of original instrument software 103 may be pre-stored in the local hard disk of the terminal device 10. It should be noted that, although only four pieces of original instrument software 103 are shown in FIG. 1, the quantity is not construed as a limitation on the quantity of original instrument software 103.

The interface 20 is a device configured to connect the terminal device 10 and the to-be-diagnosed automobile. The device may be specifically a vehicle diagnosis adapter (VCI) adapted to a piece of original instrument software 103 of a preset type. The piece of original instrument software 103 of the preset type may be original instrument software 103 of all types currently used in the field. The interface 20 may communicate with the terminal device 10 based on communication standards such as J2534, DPUD, RP1210 and the like. The interface 20 may communicate with the to-be-diagnosed automobile based on hardware communication protocols such as CAN communication, K-line communication, PWM communication, VPW communication and the like. In this embodiment, the interface 20 supports three main automobile communication standards and is adapted to all of the original instrument software 103. It should be noted that, although only one interface 20 is shown in FIG. 1, in other optional embodiments, a plurality of interfaces 20 may be used according to the communication standard or a brand corresponding to the piece of original instrument software 103. After piece of original instrument software 103 is determined, an interface 20 corresponding to the piece of original instrument software 103 is selected from the plurality of interfaces 20.

In this embodiment, during the automobile diagnosis by using the foregoing terminal device 10, the terminal device 10 acquires original software information of the automobile, determines a piece of original instrument software for the automobile diagnosis from the plurality of pieces of original instrument software 103 according to the original software information, and determines a virtual machine for running the piece of original instrument software 103 from the plurality of virtual machines. The determined original instrument software 103 communicates with the automobile by using the interface 20 to acquire fault data. Finally, the virtual machine is controlled to run the piece of original instrument software 103. Therefore, the piece of original instrument software 103 analyzes the fault data of the automobile to complete the diagnosis of the automobile.

During the communication between the piece of original instrument software 103 and the automobile by using the interface 20, an automobile bus configured to acquire the data may be a CAN bus, a K line, an Ethernet bus, a serial port line or the like. An automobile bus protocol for acquiring the data may be communication protocols such as ISO15765, ISO11898, TP20, TP16, KWP2000, KWP1281, ISO 14230, ISO 9141, PWM, VWP, SCI or the like.

The fault data is a data stream reflecting working situations of various electronic elements of the automobile. The fault data is data read by the piece of original instrument software 103. The fault data varies with time and a working condition. During transmission of the fault data from the automobile to the terminal device 10, the data is transmitted to the piece of original instrument software 103 one piece by one piece by using a data line in a form of a queue.

The original software information is all configuration information of the automobile in factory, including a name, a color, a fuel consumption, a displacement, a system model, an engine model and the like of the automobile. The original software information is used for determining to-be-used original instrument software 103. In this embodiment, the original software information may be acquired in two manners. In a first manner, original software information that needs to be loaded is acquired from a remote server. The remote server may be a local server or a third-party server and stores original software information of all vehicle types. The remote server may be searched according to a VIN of the automobile for original software information corresponding to the VIN, so as to acquire the original software information. In a second manner, the VIN of the automobile is acquired from the automobile bus, and then a table is searched according to the VIN to acquire the original software information that needs to be loaded. The VIN is a vehicle identification number. The expression “search a table” means searching an automobile parameter information table corresponding to the VIN. Each VIN has a corresponding automobile parameter information table. Different VINs may correspond to the same automobile parameter information table or different automobile parameter information tables. The automobile parameter information table is used for reflecting all configurations of the automobile. After the original software information that needs to be loaded is acquired by searching the table according to the VIN, the original software information may be directly read from the automobile, or may be acquired in other manners.

For determining the virtual machine for running the piece of original instrument software from the plurality of virtual machines, the plurality of virtual machines and the plurality of pieces of original instrument software 103 may be preset into a one-to-one correspondence. After a piece of original instrument software 103 is determined, a virtual machine corresponding to the determined original instrument software 103 is directly selected. Alternatively, the virtual machine for running the piece of original instrument software 103 may be automatically selected by a system of the terminal device 10. Alternatively, the virtual machine for running the piece of original instrument software 103 may be selected by a user.

In some other optional embodiments, referring also to FIG. 1, the automobile diagnosis system 100 further includes a cloud server 30. The cloud server 30 is communicatively connected to the terminal device 10 and is configured to remotely control the terminal device 10 to perform diagnosis for the automobile. Specifically, the cloud server 30 establishes a connection to the client software 101 by using the mobile Internet, a wireless network or a wired network. The user may input a command to the cloud server 30. The input command is transmitted to the client software 101 by using the network. The client software 101 performs a corresponding operation according to the input command. The virtual machine for running the piece of original instrument software 103 may be determined from the plurality of virtual machines according to the input command. That is to say, the user selects the virtual machine corresponding to the piece of original instrument software 103. Alternatively, the virtual machine may be controlled according to the input command to run the piece of original instrument software 103. That is to say, the user remotely operates the virtual machine and the piece of original instrument software 103 to perform diagnosis for the automobile. It is worth noting that the user may be specifically an expert in the field to provide help during the automobile diagnosis. In this way, complexity of the automobile diagnosis is reduced, and reliability of the automobile diagnosis is improved.

Moreover, in addition to transmitting the command to the terminal device 10 by using the cloud server 30, parameter data such as the diagnosis result of the automobile that is transmitted back by the terminal device 10 may also be received by using the cloud server 30. The diagnosis result may be stored in the cloud server 30 for viewing by the user.

In some other optional embodiments, the user may also operate the terminal device 10 locally. For example, the user selects, by using the client software 101 of the terminal device 10, the virtual machine for running the piece of original instrument software 103. For another example, the virtual machine is controlled by using the client software 101 to run the piece of original instrument software 103 and so on.

The embodiments of the disclosure provide an automobile diagnosis system. In the system, the virtual machine software and the plurality of pieces of original instrument software are installed in the terminal device and the plurality of virtual machines are run in the virtual machine software. During the automobile diagnosis, the piece of original instrument software for the current automobile diagnosis is determined from the plurality of pieces of original instrument software, the virtual machine for running the piece of original instrument software is selected from the plurality of virtual machines, then the fault data of the automobile is read by using the determined original instrument software, and finally the virtual machine is controlled to run the piece of original instrument software. During the running, the piece of original instrument software performs fault diagnosis on the automobile. The user may remotely control, by using the cloud server, the virtual machine to run the piece of original instrument software. On one hand, in this implementation, the terminal device for the automobile diagnosis includes the plurality of pieces of original instrument software installed locally in the terminal device. Therefore, the implementation is applicable to diagnosis of automobiles of many types, has an enhanced universality, and improves stability of automobile diagnosis. On another hand, this implementation can achieve remote automobile diagnosis, obtain help from experts, reduce the difficulty of the automobile diagnosis, and improve the reliability of the automobile diagnosis. On still another hand, the foregoing automobile diagnosis system integrates different pieces of original instrument software into one system, and runs the pieces of original instrument software separately by using the virtual machines. Therefore, the various pieces of original instrument software in the system are not affected by each other. During the automobile diagnosis, the pieces of original instrument software are run independently in the virtual machines.

Referring to FIG. 2, FIG. 2 is a flowchart of an automobile diagnosis method according to an embodiment of the disclosure. The method is applicable to the foregoing terminal device 10, and the method includes the following steps:

Step S10: Determine a piece of original instrument software for automobile diagnosis from the plurality of pieces of original instrument software.

The determining a piece of original instrument software for automobile diagnosis from the plurality of pieces of original instrument software includes: acquiring original software information of the automobile and determining the piece of original instrument software for the automobile diagnosis from the plurality of pieces of original instrument software.

The acquiring original software information of the automobile includes: acquiring a VIN of the automobile and acquiring the original software information of the automobile according to the VIN; or acquiring the original software information of the automobile from the remote server.

Step S20: Determine a virtual machine for running the piece of original instrument software from the plurality of virtual machines.

A command inputted by a user may be received, and the virtual machine for running the original instrument software may be determined from the plurality of virtual machines according to the command inputted by the user. The command inputted by the user is a command transmitted by the user to the terminal device by using a third-party device (such as a cloud server or the like).

Step S30: Acquire fault data of the automobile. The fault data may be specifically data read by the foregoing determined original instrument software from the automobile.

Step S40: Control the virtual machine to run the piece of original instrument software, so that the piece of original instrument software analyzes the fault data to perform diagnosis for the automobile.

Controlling the virtual machine to run the piece of original instrument software includes: receiving an input command from a user, the input command being a command transmitted by the user to the terminal device by using a cloud server; and controlling, according to the input command from the user, the virtual machine to run the piece of original instrument software.

In some other optional embodiments, referring also to FIG. 2, the method further includes:

Step S50: Transmit a diagnosis result of the automobile to the user.

It should be noted that, for details of the automobile diagnosis method in this embodiment of the disclosure, reference may be made to the embodiment of the automobile diagnosis system provided in the disclosure, and the details will not be described herein again.

The embodiments of the disclosure provide an automobile diagnosis method. In the method, the virtual machine software and the plurality of pieces of original instrument software are installed in the terminal device, and the plurality of virtual machines are run in the virtual machine software. During the automobile diagnosis, the piece of original instrument software for the current automobile diagnosis is determined from the plurality of pieces of original instrument software, the virtual machine for running the piece of original instrument software is selected from the plurality of virtual machines, then the fault data of the automobile is read by using the determined original instrument software, and finally the virtual machine is controlled to run the piece of original instrument software. During the running, the original instrument software performs fault diagnosis on the automobile. The user may remotely control, by using the cloud server, the virtual machine to run the piece of original instrument software. On one hand, in this implementation, the terminal device for the automobile diagnosis includes the plurality of pieces of original instrument software installed locally in the terminal device. Therefore, the implementation is applicable to diagnosis of automobiles of many types, has an enhanced universality, and improves stability of automobile diagnosis. On another hand, this implementation can achieve remote automobile diagnosis, obtain help from experts, reduce the difficulty of the automobile diagnosis, and improve the reliability of the automobile diagnosis. On still another hand, the foregoing automobile diagnosis system integrates different pieces of original instrument software into one system, and runs the pieces of original instrument software separately by using the virtual machines. Therefore, the various pieces of original instrument software in the system are not affected by each other. During the automobile diagnosis, the pieces of original instrument software are run independently in the virtual machines.

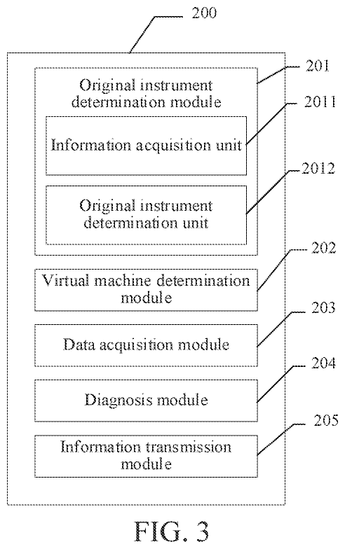

Referring to FIG. 3, FIG. 3 is a schematic structural diagram of an automobile diagnosis apparatus according to an embodiment of the disclosure. As shown in FIG. 3, an automobile diagnosis apparatus 200 is applicable to the terminal device 10. The automobile diagnosis apparatus 200 includes an original instrument determination module 201, a virtual machine determination module 202, a data acquisition module 203 and a diagnosis module 204.

The original instrument determination module 201 is configured to determine a piece of original instrument software for automobile diagnosis from the plurality of pieces of original instrument software. The virtual machine determination module 202 is configured to determine a virtual machine for running the piece of original instrument software from the plurality of virtual machines. The data acquisition module 203 is configured to acquire fault data of the automobile. The diagnosis module 204 is configured to control the virtual machine to run the piece of original instrument software. The piece of original instrument software analyzes the fault data to perform diagnosis for the automobile.

Referring also to FIG. 3, the original instrument determination module 201 that is shown includes an information acquisition unit 2011 and an original instrument determination unit 2012. The information acquisition unit 2011 is configured to acquire original software information of the automobile. The original instrument determination unit 2012 is configured to determine the piece of original instrument software for the automobile diagnosis from the plurality of pieces of original instrument software according to the original software information.

The information acquisition unit 2011 is specifically configured to acquire a VIN of the automobile and acquiring the original software information of the automobile according to the VIN; or acquire the original software information of the automobile from a remote server.

The diagnosis module 204 is specifically configured to:

receive an input command from a user, the input command being a command transmitted by the user to the terminal device by using a cloud server; and

control, according to the input command from the user, the virtual machine to run the piece of original instrument software, so that the piece of original instrument software analyzes the fault data to perform diagnosis for the automobile.

In other optional embodiments, referring also to FIG. 3, the automobile diagnosis apparatus 200 further includes an information transmission module 205. The information transmission module 205 is configured to transmit a diagnosis result of the automobile to the user.

It should be noted that content such as information exchange and an execution process between the modules and units in the apparatus is based on a same idea as the method embodiments of the disclosure. Therefore, for details, reference may be made to descriptions in the method embodiments of the disclosure, and the details will not be described herein again.

The embodiments of the disclosure provide an automobile diagnosis apparatus. In the apparatus, the virtual machine software and the plurality of pieces of original instrument software are installed in the terminal device, and the plurality of virtual machines are run in the virtual machine software. During the automobile diagnosis, the piece of original instrument software for the current automobile diagnosis is determined from the plurality of pieces of original instrument software by using the original instrument determination module, the virtual machine for running the piece of original instrument software is selected from the plurality of virtual machines by using the virtual machine determination module 202, then the determined original instrument software is controlled by using the data acquisition module to read the fault data of the automobile, and finally the virtual machine is controlled by using the diagnosis module to run the piece of original instrument software. During the running, the piece of original instrument software performs fault diagnosis on the automobile. The user may remotely control, by using the cloud server, the virtual machine to run the piece of original instrument software. On one hand, in this implementation, the terminal device for the automobile diagnosis includes the plurality of pieces of original instrument software, installed locally in the terminal device. Therefore, the implementation is applicable to diagnosis of automobiles of many types, has an enhanced universality, and improves stability of automobile diagnosis. On another hand, this implementation can achieve remote automobile diagnosis, obtain help from experts, reduce the difficulty of the automobile diagnosis, and improve the reliability of the automobile diagnosis. On still another hand, the foregoing automobile diagnosis system integrates different pieces of original instrument software into one system, and runs the pieces of original instrument software separately by using the virtual machines. Therefore, the various pieces of original instrument software in the system are not affected by each other. During the automobile diagnosis, the pieces of original instrument software are run independently in the virtual machines.

The foregoing described device embodiments are merely examples. The units described as separate parts may or may not be physically separate. The parts displayed as units may or may not be physical units, may be located in one position, or may be distributed on a plurality of network units. Some or all of the modules may be selected according to actual needs to achieve the objectives of the solutions of the embodiments.

Based on the descriptions of the foregoing implementations, those of ordinary skill in the art may clearly understand that the implementations may be implemented by software in addition to a universal hardware platform, or by hardware. Those of ordinary skill in the art may understand that, all or some of the processes of the method in the foregoing embodiments may be implemented by a computer program instructing relevant hardware. The program may be stored in a computer-readable storage medium. During execution of the program, the processes of the foregoing method embodiments may be included. The foregoing storage medium may include a magnetic disc, an optical disc, a read-only memory (ROM), a random access memory (RAM), or the like.

Finally, it should be noted that the foregoing embodiments are merely used for describing the technical solutions of the disclosure, but are not intended to limit the disclosure. Under the concept of the disclosure, the technical features in the foregoing embodiments or different embodiments may be combined, the steps may be implemented in any sequence, and there may be many other changes in different aspects of the disclosure as described above. For brevity, those are not provided in detail. The disclosure is described in detail with reference to the foregoing embodiments. However, those of ordinary skill in the art should understand that they may still perform modifications to the technical solutions described in the foregoing embodiments or perform equivalent replacements to some technical features thereof, without departing from the scope of the technical solutions of the embodiments of the disclosure.

What is claimed is:

1. An automobile diagnosis method, applicable to a terminal device, the terminal device being communicatively connected to an automobile, the terminal device comprising a virtual machine software and a plurality of pieces of original instrument software, the virtual machine software running a plurality of virtual machines, and the method comprising:
determining a piece of original instrument software for automobile diagnosis from the plurality of pieces of original instrument software;
determining a virtual machine for running the piece of original instrument software from the plurality of virtual machines;
acquiring fault data of the automobile; and
controlling the virtual machine to run the piece of original instrument software, so that the piece of original instrument software analyzes the fault data to perform diagnosis for the automobile.

2. The method according to claim 1, wherein determining a piece of original instrument software for automobile diagnosis from the plurality of pieces of original instrument software comprises:
acquiring original software information of the automobile; and
determining the piece of original instrument software for the automobile diagnosis from the plurality of pieces of original instrument software according to the original software information.

3. The method according to claim 2, wherein acquiring original software information of the automobile comprises:
acquiring a vehicle identification number (VIN) of the automobile and acquiring the original software information of the automobile according to the VIN; or
acquiring the original software information of the automobile from a remote server.

4. The method according to claim 1, wherein controlling the virtual machine to run the piece of original instrument software comprises:
receiving an input command from a user, the input command being a command transmitted by the user to the terminal device via a cloud server; and
controlling, the virtual machine to run the piece of original instrument software according to the input command from the user.

5. The method according to claim 4, further comprising:
transmitting a diagnosis result of the automobile to the user.

6. An automobile diagnosis apparatus, applicable to a terminal device, the terminal device being communicatively connected to an automobile, the terminal device comprising virtual machine software and a plurality of pieces of original instrument software, the virtual machine software running a plurality of virtual machines, and the apparatus comprising:
an original instrument determination module, configured to determine a piece of original instrument software for automobile diagnosis from the plurality of pieces of original instrument software;
a virtual machine determination module, configured to determine a virtual machine for running the piece of original instrument software from the plurality of virtual machines;
a data acquisition module, configured to acquire fault data of the automobile; and
a diagnosis module, configured to control the virtual machine to run the piece of original instrument software, so that the piece of original instrument software analyzes the fault data to perform diagnosis for the automobile.

7. The apparatus according to claim 6, wherein the original instrument determination module comprises:
an information acquisition unit, configured to acquire original software information of the automobile; and
an original instrument determination unit, configured to determine the piece of original instrument software for the automobile diagnosis from the plurality of pieces of original instrument software according to the original software information.

8. The apparatus according to claim 7, wherein the information acquisition unit is specifically configured to:
acquire a VIN of the automobile and acquire the original software information of the automobile according to the VIN; or
acquire the original software information of the automobile from a remote server.

9. The apparatus according to claim 6, wherein the diagnosis module is specifically configured to:
receive an input command from a user, the input command being a command transmitted by the user to the terminal device via a cloud server; and
control the virtual machine to run the piece of original instrument software according to the input command from the user, so that the piece of original instrument software analyzes the fault data to perform diagnosis for the automobile.

10. The apparatus according to claim 9, further comprising:
an information transmission module, configured to transmit a diagnosis result of the automobile to the user.

11. An automobile diagnosis system, comprising a terminal device and an interface, wherein:
the interface is configured to connect the terminal device to an automobile, the terminal device comprising a virtual machine software and a plurality of pieces of original instrument software, the virtual machine software running a plurality of virtual machines; and
the terminal device comprises at least one processor and a memory communicatively connected to the at least one processor, the memory storing instructions which are executable by the at least one processor to perform an automobile diagnosis method, the method comprising:
determining a piece of original instrument software for automobile diagnosis from the plurality of pieces of original instrument software;
determining a virtual machine for running the piece of original instrument software from the plurality of virtual machines;
acquiring fault data of the automobile; and
controlling the virtual machine to run the piece of original instrument software, so that the piece of original instrument software analyzes the fault data to perform diagnosis for the automobile.

12. The system according to claim 11, further comprising:
a cloud server communicatively connected to the terminal device and configured to remotely control the terminal device to perform diagnosis for the automobile.

13. The system according to claim 11, wherein the interface is a vehicle diagnosis adapter adapted to original instrument software of a preset type.

14. The system according to claim 11, wherein determining a piece of original instrument software for automobile diagnosis from the plurality of pieces of original instrument software comprises:
acquiring original software information of the automobile; and
determining the piece of original instrument software for the automobile diagnosis from the plurality of pieces of original instrument software according to the original software information.

15. The system according to claim 14, wherein acquiring original software information of the automobile comprises:
acquiring a vehicle identification number (VIN) of the automobile and acquiring the original software information of the automobile according to the VIN; or
acquiring the original software information of the automobile from a remote server.

16. The system according to claim 11, wherein controlling the virtual machine to run the piece of original instrument software comprises:
receiving an input command from a user, the input command being transmitted by the user to the terminal device via a cloud server; and
controlling the virtual machine to run the piece of original instrument software according to the input command from the user.

17. The system according to claim 16, wherein the method further comprises:
transmitting a diagnosis result of the automobile to the user.
